(19) United States
(12) Patent Application Publication
(10) Pub. No.: US 2008/0036878 A1
(43) Pub. Date: Feb. 14, 2008

(54) System for Capturing and Displaying Images

(76) Inventors: Roland Schmid, Stuttgart (DE); Ulrich Seger, Warmbronn (DE); Jens Schick, Herrenberg (DE)

Correspondence Address: KENYON & KENYON LLP, ONE BROADWAY, NEW YORK, NY, 10004, US

(21) Appl. No.: 11/665,429

(22) PCT Filed: Aug. 31, 2005
(86) PCT No.: PCT/EP05/54286

§ 371 Date: Sep. 14, 2007

(30) Foreign Application Priority Data
Oct. 13, 2004 (DE) 10 2004 049 872.5

(51) Int. Cl. H04N 5/76

(52) U.S. Cl. 348/231.99; 348/E05.024

(57) ABSTRACT

A system 1 for capturing and displaying images is described, which includes a camera module 10 having an image sensor 11, a display unit 18 and a control unit 17. The camera module 10 includes a memory module 14 for storing patterns and messages as well as a function module 13 for superimposing patterns and/or messages stored in the memory module 14 upon an image of the image sensor 11.

### FIELD OF THE INVENTION

The present invention relates to a system for capturing and displaying images. The system may be suitable as a driver assistance system to support the driver of a motor vehicle. However, the present invention is not limited to this usage, but is suitable for use in all usages in which a video image containing superimposed symbols and/or text is to be represented on a display device, in particular a monitor.

### BACKGROUND INFORMATION

Increasingly, vehicles are being provided with park pilot systems intended to facilitate parking as part of the original equipment. A park pilot system of this type includes short-range sensors which preferably measure the distance to an obstacle via ultrasound. A park pilot system also includes visual and/or acoustic signal transducers which generate a visual and/or acoustic warning signal as a function of the output signals of the sensors. Although a park pilot system of this type already provides highly suitable support for the driver, the common signal transducers today are highly abstract and unclear. Inexperienced drivers, in particular, find it highly difficult to correctly interpret the signals emitted by the signal transducer. Furthermore, the use of video cameras in a vehicle for monitoring the vehicle surroundings is conventional. The video signal of the video camera is displayed on a monitor situated within the driver's field of vision.

A method and a device for visualizing a vehicle path is described in PCT International Published Patent Application No. WO 00/74976, a path of a vehicle to be expected at a constant steering angle being represented on a display on which at least a portion of the travel area behind a vehicle is displayed. A driver is informed of the path to be expected so that he can adjust the adopted steering angle to an obstacle which is visible in the travel area behind the vehicle.

In addition, a parking assistance device is described in German Published Patent Application No. 100 15 897 for recording an image of a back of a vehicle by a camera during a parking operation, for displaying an image from the camera on a screen which is provided inside the vehicle, in the form of a rear image, and for displaying an anticipated motion path which varies in agreement with a status of a steering angle to superimpose the rear image. The parking assistance device includes a parking instruction unit for providing instructions on parking the vehicle along a longitudinal line and a display unit for an anticipated motion path, including a turn-in point, in agreement with the steering wheel angle when the vehicle is instructed by the parking instruction unit to park along the longitudinal line.

### SUMMARY

Example embodiments of the present invention provide that a system for capturing and displaying images via a camera module is able to receive simple signals from a control unit and superimpose patterns or messages assigned to these signals upon a recorded image and represent this image on a display unit such as, in particular, a monitor. For this purpose, the camera module includes a memory module for storing patterns and/or messages as well as a function module for superimposing patterns and/or messages stored in the memory module upon an image of an image sensor. Codes may be assigned to the stored patterns and messages and may be used to retrieve the patterns and messages from the memory module. Since these codes are only comparatively short messages, the provision thereof is associated with only minimal load on the computing capacity of a control unit cooperating with the camera module. The camera module may include at least one interface each for exchanging data with a control unit and a monitor. This makes it possible to easily operate the camera module at a remote location from the control unit and the monitor. For example, the camera module may therefore be optimally situated in the rear area of a vehicle for monitoring the surroundings of the vehicle rear, while the monitor remains in the driver's field of vision.

The transmission of codes may be controlled by output signals of a distance warning unit. In this manner, patterns and messages which facilitate backing up or parking may be superimposed upon a video image provided by an image sensor.

Exemplary embodiments of the present invention are explained in greater detail below with reference to the appended Figures.

### BRIEF DESCRIPTION OF THE DRAWINGS

FIG. 1 shows a block diagram of a system for capturing and displaying images.

FIG. 2 shows the representation of a video image with superimposed patterns and messages on a monitor.

FIG. 3 shows the block diagram of a dual buffer.

### DETAILED DESCRIPTION

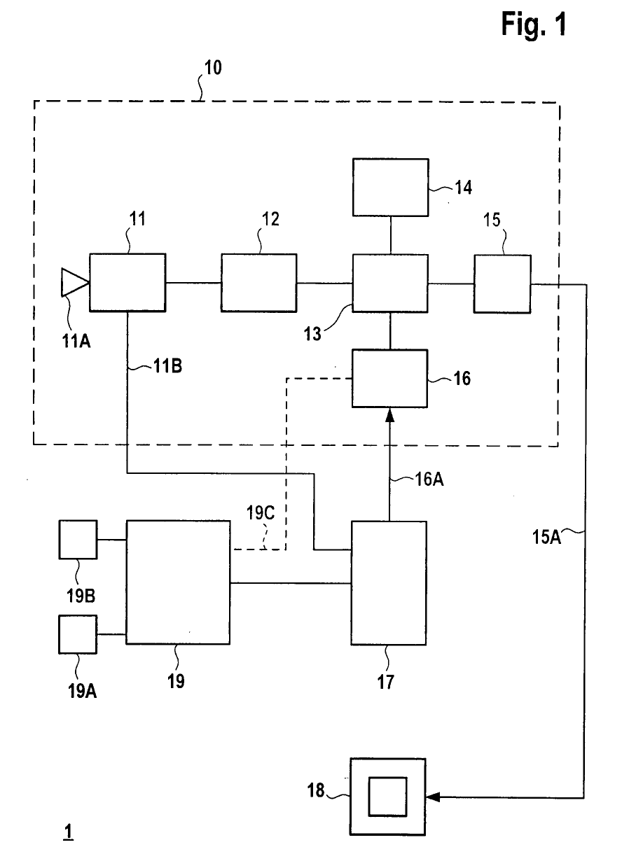

FIG. 1 shows the block diagram of a system according to example embodiments of the present invention for capturing and displaying images 1. System 1 includes a camera module 10, a distance warning unit 19, 19A, 19B, a display unit such as, in particular, a monitor 18 and a control unit 17. Camera module 10 includes an image sensor 11 to which a function module 12 is connected. Function module 12 is connected to a function module 13. Function module 13 is connected to a memory module 14 and also to a function module 16. Function module 13 is also connected to a function module 15. Function module 16 includes an input terminal 16A via which the module is connected to a control unit 17. Function module 15 includes an output terminal 15A via which camera module 10 is connectable to a monitor 18. Image sensor 11 may include a light-sensitive semiconductor chip, e.g., a CCD sensor, and an optical module 11A which maps scenes from the recording area of image recording and display system 1 to the semiconductor chip. A wide-angle lens having an aperture angle of approximately 100° to 120° may be used as optical module 11A. Image sensor 11 provides a raw image at its output which is supplied to the input of function module 12. Function module 12 corrects distortion in the raw image provided by image sensor 11 and supplies a corrected image to function module 13. To make do with as little computing power as possible, presettable patterns and messages may be stored in memory module 14 connected to function module 13. The patterns may be, for example, simple geometric structures such as interrupted and uninterrupted lines of different widths and colors. These lines may be setpoint and actual trajectories and/or distance lines which signal, for example, a specific distance to an obstacle. The stored patterns may also be warning symbols, pictograms, road signs, etc. The stored messages may be short advisories and warnings in text form which are intended to support the driver. In particular, the messages also include failure messages which indicate errors in the system hereof and/or errors in other systems of the vehicle. In an example embodiment, memory module 14 includes a standard set of patterns and messages. The contents of memory module 14 may be adapted on a customer-specific basis. For example, the contents may be adapted such that customer-specific information is added to the standard set of patterns and messages. Alternatively, the standard set may also be deleted and completely replaced by a customer-specific set of patterns and messages. Function module 13 is connected to function module 16. Function module 16, in turn, is connected via an input terminal 16A to a control unit 17 which controls the function of camera module 10, as described below. In addition, the control unit is connected to a distance warning unit 19 which also includes multiple sensors 19A, 19B. Ultrasound sensors may be provided as sensors 19A, 19B. The use of radar and laser sensors is also possible. Function module 13 is also connected to a function module 15, which has an output terminal 15A. Via this output terminal 15A, camera module 10 is connected to a display unit for images, such as, in particular, a monitor 18. The main purpose of function module 15 is to adapt the output signals of function module 13 to monitor 18 used in each case. In an exemplary embodiment of the present invention, for example, a color monitor 18 according to the NTSC standard is connected. As an interface, function module 15 therefore may provide output signals according to this standard. A characteristic of system 1 is that it is possible to superimpose the patterns and/or message stored in the memory unit upon the images captured by image sensor 11, using comparatively simple control signals of control unit 17. As a result, the computing power of the control unit is not unduly burdened. This is accomplished by assigning a unique code to each pattern and each message stored in memory module 14 and storing the codes in both control unit 17 and in memory unit 14. If a particular pattern or a particular message is to be retrieved from memory unit 14, control unit 17 consequently transmits only the code corresponding to this pattern or this message to memory unit 14 via function module 16 and function module 13. By transmitting this code, the corresponding pattern or the corresponding message is provided to function module 13 by memory module 14. Function module 13 acts as a mixing unit in which a pattern or a message provided by memory unit 14 is superimposed upon the equalized image of image sensor 11 provided by function module 12. An image provided with comments is thus available for display on a monitor 18 at output terminal 15A of camera module 10. In the described exemplary embodiment, the output of the code to be transmitted is controllable by distance warning unit 19 via its sensors 19A, 19B. The patterns and/or messages to be superimposed upon the video image by outputting a code may therefore relate to distance information of the vehicle with regard to the vehicle surroundings. In other usages, the output of codes may be controlled by other units. For example, signals of a restraint system for vehicle occupants may control the output of codes when danger is imminent. The message retrieved by the corresponding code may be superimposed upon a video image. An item of information may be extracted from the video image generated by image sensor 11, and this information may be used to output a code, including subsequent superimposition of a message stored in memory module 14 upon the video image. This is suitable, for example, if image sensor 11 is used as a precrash sensor. For this purpose, a connecting line 11B may be provided between image sensor 11 and control unit 17.

A control unit 17 may not be needed if distance warning unit 19 itself already has an interface which generates the corresponding codes. As indicated by broken connecting line 19C in FIG. 1, distance warning unit 19 is connected directly to function module 16.

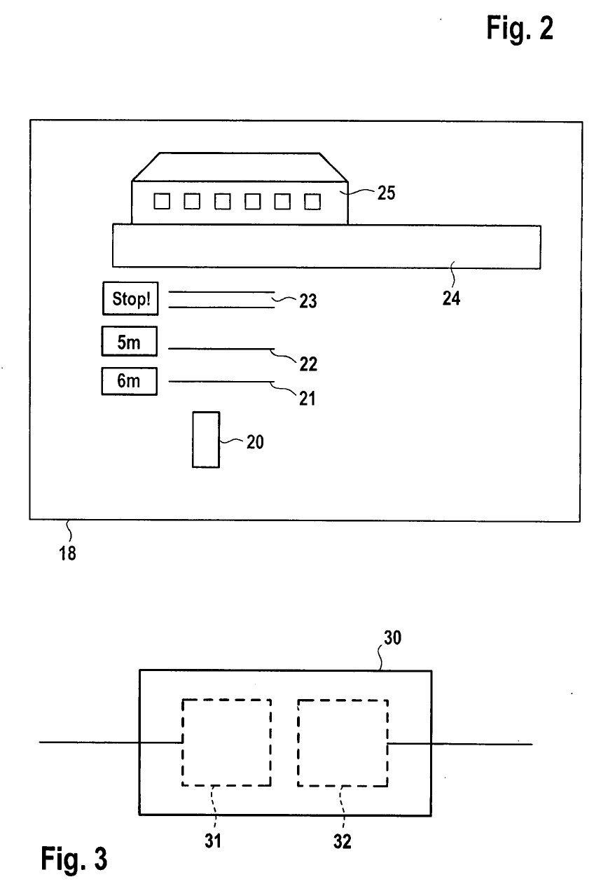

The operation of system 1 for capturing and displaying images is described below. In particular, the superimposition of patterns and/or messages upon an image recorded by image sensor 11 is also explained on the basis of an example embodiment (FIG. 2). Image sensor 11, including upstream optical module 11A, captures a scene from the surroundings of vehicle 20 (FIG. 2) and stores the captured image continuously in an input image memory. Image sensor 11 may have at least VGA resolution. The input image memory has a storage capacity of approximately 350 Kbytes. The distortion in the image is corrected in function module 12. The corrected image is stored in an output image memory which, in an exemplary embodiment, may have a storage capacity of approximately 1 Mbyte. Patterns and messages, along with the codes assigned to them, are stored in memory module 14. For example, lines of different designs and colors or more complex symbols are possible as patterns. The lines may each be assigned to a steering angle. In an exemplary embodiment of the present invention, lines are assigned to each of 64 values of selected steering angles. Additional lines are provided to represent distance values or artifacts, for example, a displayed bumper, reflective signs, etc. In addition, vehicle symbols, road signs and roadway structures may also be stored. Messages in text form, such as information and warning texts as well as failure messages, are also stored. FIG. 2 shows a scene from the surroundings of a vehicle 20, represented on a monitor 18. The scene shows a house 25 delimited by a wall 24. A vehicle 20 is preparing to park by backing up into a parking space in front of wall 24. The parking operation is monitored by a distance warning unit 19 having sensors 19A, 19B (FIG. 1). Patterns and messages, which are shown along with the codes assigned to them in the following table, are displayed on the video image represented on monitor 18.

| Code | Pattern/message |
|---|---|
| 1 | Vehicle symbol 20 |
| 2 | Line 21 |
| 3 | Line 22 |
| 4 | Double line 23 |
| 5 | Text: “6m” |
| 6 | Text: “5m” |
| 7 | Text: “Stop!” |

These patterns and messages are stored in memory module 14 of camera module 10, together with numerous other patterns and messages. They are retrieved by a corresponding code which is transmitted by control unit 17 to camera module 10. In the exemplary embodiment being discussed, code “1” corresponds to a rectangular vehicle symbol which represents vehicle 20. Code 2 corresponds to a line 21, which is displayed in the image on monitor 18 at a distance of 6 meters from wall 24. Code 5 corresponds to text message “6 m”, which is displayed in relation to line 21. Double line 23 and corresponding text message “Stop!” signal the driver of vehicle 20 that he should bring vehicle 20 to a stop at this double line 23 so that the vehicle may assume an optimum parking position. Double line 23 and text message “Stop!” are retrieved via codes 4 and 7. In the present exemplary embodiment, the transmission of the different codes is authoritatively determined by output signals of distance warning unit 19, which evaluates the signals of sensors 19A, 19B assigned to this unit. Sensors 19A, 19B may be ultrasound sensors which measure the distance of the rear of vehicle 20 from wall 24. Lines 21, 22, 23 and the assigned text messages may be displayed, for example, when sensors 19A, 19B have measured a corresponding distance. The patterns and messages may be stored in memory module 14 in a number of different variations and be retrieved by assigned codes. Thus, lines 21, 22, 23, for example, may be represented by different types of strokes in the form of solid lines, dotted lines or broken lines. Lines of different widths or different colors may also be represented. Different patterns and messages may also be linked with each other. All these measures are controllable by assigned codes. Because control unit 17 must only provide codes, while the patterns and messages corresponding to the transmitted codes are available for retrieval from memory module 14 in camera module 10, control unit 17 itself makes do with a substantially reduced computing power.

The code transfer process is explained below. The codes may be stored asynchronously in a dual buffer 30 (FIG. 3) which includes a read buffer and a write buffer 32, 31. In an exemplary embodiment of the present invention, read and write buffers 32, 31 each accommodate 32 codes. Write buffer 31 is filled via input 16A. The exchange between the read and write buffers may also be controlled via a special code. Read buffer 32 is read image-synchronously.

The patterns and/or messages retrievable by codes are superimposed upon the video image provided by image sensor 11 as follows. The image generated by image sensor 11 is written continuously to an input memory. The image is corrected via function module 12 and converted to an output image. The codes stored in read buffer 32 are output consecutively therefrom. The patterns and/or messages corresponding to the output codes are retrieved from memory module 14 and superimposed upon the output image in function module 13. The image data are provided for display on monitor 18 by function module 15.

CAMERA MODULE 10 MAY BE OPERABLE AT A REMOTE LOCATION FROM CONTROL UNIT 17 AND MONITOR 18. THIS IS PARTICULARLY SUITABLE IF SYSTEM 1 IS USED AS A DRIVER ASSISTANCE SYSTEM IN WHICH THE CAMERA MODULE IS SITUATED IN THE REAR AREA OF A VEHICLE 20 SUCH THAT THE REAR TRAFFIC AREA MAY BE MONITORED, WHILE MONITOR 18 IS SITUATED IN THE DRIVER'S FIELD OF VISION. CONTROL UNIT 17 MAY BE SITUATED IN ANY POSITION WITHIN THE VEHICLE. CAMERA MODULE 10 HAS AT LEAST ONE CORRESPONDING INTERFACE 15, 16 FOR EXCHANGING DATA WITH CONTROL UNIT 17 AND MONITOR 18.

1-10. (canceled)

11. A system for capturing and displaying images, comprising:
a camera module including an image sensor, a memory module configured to store patterns and messages, and a function module configured to superimpose at least one of (a) patterns and (b) messages stored in the memory module upon an image of the image sensor;
a display unit; and
a control unit.

12. The system according to claim 11, wherein codes are assigned to at least one of (a) the patterns and (b) the messages stored in the memory module, at least one of (a) the patterns and (b) the messages retrievable from the memory module by transmission of the code corresponding to the at least one of (a) the patterns and (b) the messages.

13. The system according to claim 11, wherein the camera module includes a function module configured to correct distortion in images captured by the image sensor.

14. The system according to claim 11, wherein the camera module includes at least one interface configured to exchange data with the display unit.

15. The system according to claim 11, wherein the camera module includes at least one interface configured to exchange data with the control unit.

16. The system according to claim 11, wherein the memory module is configured to store at least one of (a) geometric patterns, (b) lines, (c) road signs and (d) symbols and text messages, the display configured to display at least one of (a) the geometric patterns, (b) the lines, (c) the road signs and (d) the symbols and the text messages controllable by codes.

17. The system according to claim 11, wherein the camera module includes a dual buffer for codes including a write buffer and a read buffer.

18. The system according to claim 17, wherein storage capacities of the read and the write buffers are substantially the same.

19. The system according to claim 11, further comprising a distance warning unit configured to output signals to control transmission of codes.

20. The system according to claim 11, wherein the camera module is arranged as an assembly operable at a remote location from the control unit and the display unit, the camera module including interfaces configured to connect the camera module to the control unit and the display unit.
